(19) United States
(12) Patent Application Publication
(10) Pub. No.: US 2006/0183813 A1
(43) Pub. Date: Aug. 17, 2006

(54) Hot melt coating compositions and methods of preparing same

(76) Inventors: Jitendra Modi, Wallington, NJ (US); Edward Stone, Morris Plains, NJ (US); Ana Marie Flores, Jersey City, NJ (US); Robert Catena, Belleville, NJ (US); Robert Auerbach, Princeton Junction, NJ (US)

Correspondence Address: Sidney Persley, Esquire;Sun Chemical Corporation, 222 Bridge Plaza South, Fort Lee, NJ, 07024, US

(21) Appl. No.: 10/730,213

(22) Filed: Dec. 5, 2003

Related U.S. Application Data
(63) Continuation-in-part of application No. 10/034,004, filed on Dec. 28, 2001, now Pat. No. 6,841,590.

(51) Int. Cl. C03C 17/00; C08F 220/18

(52) U.S. Cl. 523/160; 524/390; 524/386

(57) ABSTRACT

Solvent-free hot melt coating compositions composed of a solid linear alcohol, a thermoplastic binder, and a wax which are solid at room temperature, with a melting point of about 75° C. or greater, that when heated to a temperature between about 90° C. and about 135° C., forms a molten coating composition having a viscosity between 100 cps and 1200 cps and method for preparing same.

### CROSS-REFERENCE TO RELATED APPLICATIONS

This application is a Continuation-In-Part of Application U.S. Ser. No. 10/034,004, filed Dec. 28, 2001.

### FIELD OF THE INVENTION

This invention relates to coating compositions. More particularly, the invention relates to solvent free solid hot melt coating compositions for use in hot melt coating processes.

### BACKGROUND OF THE INVENTION

Conventional coating compositions typically require organic solvents or water for their application. The use of solvents is well known to be linked with a variety of disadvantages, both for the manufacturer as well as the coater. For example the danger of fire, explosion, odor, and environmental pollution exists with solvent based coating compositions. Further, such coating compositions also lead to a lessening of the coating quality due to the presence of residual solvent, which, for example causes a decrease in the blocking temperature. Also, only certain maximum coating speeds can be achieved which are determined by the rate of evaporation of the solvent or water employed, and which cannot be sufficiently increased by modifying construction of the coating apparatus.

The problems of environmental pollution by solvents have led to the development of solvent free coating compositions which contain reactive components that are cured or hardened at elevated temperatures or by incident radiation. In particular, reactive monomers and/or oligomers have been used as vehicles for coating compositions. Such reactive coating compositions when coated are hardened on a substrate by heat, ultraviolet light or electron radiation in a very short time to form a film. While such solvent-free coating compositions have eliminated pollution by solvents, the hardened coating compositions frequently contain residual unreacted monomers which can lead to contamination in such applications as food packaging.

Hot melt coating compositions of the present invention are a new development based on the recent successful development of hot melt printing inks. Illustrative of the development of hot melt printing inks are the gravure and flexographic printing processes employing solvent free inks, which are solid at room temperature but molten at printing temperatures, such as have been disclosed in U.S. Pat. No. 4,066,585. The disclosed inks comprise a pigment and a thermoplastic binder having a softening point between 90° C. and 160° C. The binder comprises a synthetic polyamide resin or synthetic polyesteramide resin, each resin being the condensation product of (1) an acid component comprising a dimerized fatty acid and a monocarboxylic acid and (2) an amine component comprising a diamine and, in the case of the polyesteramide resin, additionally comprising a diol and/or alkanolamine.

While advances have been made in hot melt ink technology, there remains a need in the general coating arts for hot melt coating compositions which are solvent free and which do not contain residual unreacted monomers upon curing. Further, there exits a need for a coating which is solid (100%) at room temperature. There is also a need for a clear composition having a good moisture-vapor-transmission (MVTR) without using volatile solvents and other toxic ingredients or applying film lamination. Lastly, there is a need for a coating which has good adhesion to a variety of substrates such as paper, clay, coated board, film and foil.

### SUMMARY OF THE INVENTION

It has now been found that the above objectives can be realized by employing a solvent free coating composition comprising:

(A) a solid linear alcohol at room temperature;

(B) a thermoplastic binder; and

(C) a wax;

wherein, the coating composition, which is solid at room temperature, has a melting point of at least about 75° C., and when heated to a temperature between about 90° C. and about 135° C. forms a coating composition which has a coating viscosity between about 100 cps and about 1200 cps.

The present invention also provides a method of preparing a solvent free coating composition having a linear alcohol which is a solid at room temperature, a thermoplastic binder, and a wax. When heated to between about 90° C. and about 135° C. the solvent free coating composition has a coating viscosity between about 100 cps and about 1200 cps.

The present invention also provides a method for preparing a hot melt flexographic printing coating composition by preparing a pigment dispersion and mixing it with a linear alcohol which is a solid at room temperature, a thermoplastic binder, a wax and optionally, a solid plasticizer to form a homogenous solvent free coating composition having a viscosity of between about 100 cps and about 1200 cps at a temperature of between about 90° C. and about 135° C.

### DETAILED DESCRIPTION OF THE INVENTION

The present invention relates to a novel solvent free coating composition which is solid at room temperature and to a method of coating using this coating composition in a molten state, e.g., at coating temperatures of about 90° C. and higher. As used herein the term “solid” is intended to mean that the physical state of a designated component is solid at ambient room temperature, i.e., the component has a melting point or a softening temperature substantially above ambient room temperature. The solvent free coating compositions of the invention are substantially free of condensation polymers or any other such component which would change the essential character of the coating composition.

Alcohol

The solid linear alcohol in the invention functions as a dispersing medium to maintain a uniform suspension. Suitable linear alcohols include but are not limited to fully saturated, long-chain linear alcohols having a melting point of about 75° C. or greater and a number-average molecular weight (Mₙ) of about 350 or greater. Preferably, the linear alcohols have a Mₙ between about 350 and about 750 and a melting point between about 75° C. and about 110° C. Preferably, the solid linear alcohol is a C₁₄ alcohol such as Unilin® alcohols which are products of the Baker Petrolite Corp. Unilin® alcohols are fully saturated, long-chain linear alcohols having average carbon chain lengths up to C₅₀ with the primary hydroxy function of the alcohol distributed among all of the carbon chain lengths. A particularly preferred solid linear alcohol is Unilin® 500 alcohol which has a Mₙ of 550; a melting point of 99° C., a hydroxyl number of 83 mg KOH/g sample, and a viscosity at 149° C. of 5.5 cps.

Thermoplastic Binder

Thermoplastic binders for use in the present invention should have a softening point of about 70° C. and therefore be solid at ambient temperature. Suitable thermoplastic binders include but are not limited to ethylene copolymers, hydrocarbon resins or a combination thereof.

In one embodiment of the invention the thermoplastic binder is a copolymer of ethylene with either acrylic acid or vinyl acetate. In a preferred embodiment, the solid thermoplastic binder is poly(ethylene-acrylic acid) which has a Mettler Drop Pt. (ASTM D-3954) of about 90° C. to about 105° C.; a Brookfield viscosity at 140° C. of about 550 cps to about 650 CPS; and an acid number between about 40 and about 120. A particularly preferred poly(ethylene-acrylic acid) of this type is A-C® 5120 copolymer of ethylene-acrylic acid which is marketed by Honeywell (formerly Allied Signal Inc.), Specialty Chemicals, Morristown, N.J. Another preferred thermoplastic binder is A-C® 5120 copolymer which is a poly(ethylene-acrylic acid) having a Mettler Drop Pt. of 92° C., a Brookfield viscosity at 140° C. of 650 cps; and an acid number of 120. In an added embodiment of this invention, the vinyl thermoplastic binder is poly(ethylene-vinyl acetate) in which the copolymer contains between about 15 wt. % to about 50 wt. % of vinyl acetate. Poly(ethylene-vinyl acetate) copolymers of this type have Melt Indexes ranging from about 8 to about 2500 and a softening point (Ring and Ball, ASTM E28 hereinafter identified as R&B”) ranging from about 74° C. to about 150° C. Poly(ethylene-vinyl acetate) copolymers of this type which are used in the following examples are marketed by E.I. duPont deNemours and Co. as Elvax® Ethylene/VA copolymers and by Elf Atochem as Evatane® Ethylene/VA copolymers.

In another embodiment of this invention, the thermoplastic binder is a hydrocarbon resin. Typical hydrocarbon resins which are useful in formulating the coating compositions of this invention include but are not limited to Escorez 5380 (R&B softening point 85° C.), Escorez 210, (R&B softening point 94° C.), Escorez 5400 (R&B softening point 100-106° C.), and Escorez 5600 (R&B softening point 100-106° C.).

Wax

Suitable waxes for use in the invention are non-volatile at coating operating temperatures and have low melt viscosities. Such waxes or mixture of waxes provide a proper degree of toughness and flexibility to the applied coating composition for the intended application. Typical waxes for use in the present invention include but are not limited to highly branched hydrocarbon waxes, polyethylene homopolymer waxes, oxidized polyethylene waxes (such as E-2020 from Baker Petrolite), animal waxes (such as spermaceti wax), vegetable waxes (such as rice bran wax, carnuba wax and candilla wax), and combinations thereof. Preferred waxes are highly branched hydrocarbon waxes which typically have a viscosity at 99° C. of about 1-400 cps and preferably a viscosity at 99° C. of about 1-20 cps.

Waxes which have these properties include but are not limited to the animal wax spermaceti wax, which is a complex cetyl ester mixture and has a melting point of 45° C.-49° C., and Rosswax 3009 which is marketed by Frank B. Ross Co. Inc., Jersey City, N.J., and has a low molecular weight polyethylene derived from high density polyethylene, has a Mn of 1000-1200; a molecular weight distribution in the range of about 1.0 to about 2.0; a melting point (Drop D-127) of 82° C.-104° C.; and an extremely low melt viscosity. A particularly preferred wax of this type is VYBAR® 253 polymer marketed by Baker Petrolite. VYBAR® 253 polymer, which is used in the following examples, is a highly branched hydrocarbon which has a number average molecular weight (Mn) of 520 (by vapor pressure osmometry); a softening point (ASTM D36) of about 67° C.; and a viscosity at 99° C. of about 6 cps (ASTM D3236).

Solid Plasticizer

The present invention may also include one or more solid plasticizers. Suitable solid plasticizers include, but are not intended to be limited to, solid esters of benzoic acid, phthalic acids and aliphatic/cycloaliphatic acids with melting points above 40° C. and which are substantially non-volatile at coating press operating temperatures, or combinations thereof. A preferred solid plasticizer is dicyclohexylphthalate.

Method of Preparation

The solvent free coating composition of the present invention is prepared by first mixing a linear alcohol which is solid at room temperature, if present a solid plasticizer, a thermoplastic binders and waxes in a container at a temperature of at least 90° C. to form a homogeneous molten coating composition which is allowed to cool to room temperature to form the solvent free coating composition of the present invention. The coating mixture may be heated at a temperature of at least 110° C., preferable at least 120° C. The coating mixture may be heated for a period of a few hours, preferably between one to four hours, more preferably between two to three hours. The container for heating may be, but is not limited to, a metal can or aluminum pan.

Typically, the solvent free coating composition may be cooled to room temperature to form a solid coating composition which can be packaged and stored for later use in hot melt coating.

In a preferred embodiment of this invention, the solid coating composition comprises: an ethylene-acrylic acid copolymer, a linear alcohol which is a solid at room temperature, dicyclohexylphthalate, and a highly branched hydrocarbon wax. Preferably, the ethylene-acrylic acid copolymer is A-C® 5120 copolymer of ethylene-acrylic acid identified above, the solid linear alcohol is Unilin® 550 alcohol identified above, and the highly branched hydrocarbon wax is VYBAR® 253 polymer identified above. The solvent free coating compositions of this embodiment are particularly useful in hot melt coating on a variety of substrates giving applied coating compositions with very good adhesion and gloss.

In another preferred embodiment of this invention, the solid coating composition comprises a pigment; an ethylene-vinyl acetate copolymer, a solid linear alcohol at room temperature, dicyclohexylphthalate, and a polyethylene homopolymer wax. Preferably, the ethylene-vinyl acetate copolymer is Elvax® 40W ethylene-vinyl acetate copolymer (containing 40 wt. % of vinyl acetate, and has a Melt Index of about 52 and a softening point of about 104° C. (ring & ball ASTME28)), the solid linear alcohol is Unilin® 550 alcohol identified above, and the polyethylene homopolymer wax is Rosswax 3009 identified above. The solvent free coating compositions of this embodiment are particularly useful in hot melt coating on a variety of polyester substrates and treated polyethylene substrates, providing applied coating compositions with very good adhesion and gloss.

Each of the preferred solvent free coating compositions has a melting point of about 75° C. or greater, and when heated to a temperature between about 90° C. and about 135° C., forms a molten coating composition which has a viscosity between about 100 cps and about 1200 cps, preferably between about 100 cps and about 700 cps.

The solvent free coating composition of the present invention is free of volatile solvents while also avoiding the problem of unreacted residual monomers which can migrate into the substrate on which the coating is applied, such as food packaging. The solvent free coating composition is also solid and in its clear embodiment, has a good MVTR of less than 2 grams/100 in²/day at various temperatures. The solvent free coating composition of the present invention also has good adhesion to a variety of substrates such as paper, clay, coated board, film and foil.

The solvent free coating compositions as prepared herein are used in hot melt coatings. It is broken into small pieces and placed into a heated coating composition reservoir where it is melted and maintained slightly above its melting point, i.e., brought to a temperature between about 90° C. and about 135° C. to form a molten coating composition which has a viscosity between about 100 cps and about 1200 cps. The molten coating composition is then applied to a heated anilox roller in operational contact with the surface of a heated coating element, and printed from the surface of the flexographic plate onto a substrate such as conventional print stock, polymeric films, metal sheets, and the like. The use of the solvent free coating compositions of the invention in hot melt coating is more fully described in the following Examples. The coating substrate may be selected from a variety of flexible films and papers including but not limited to polypropylene film with both sides corona treated, polypropylene film with both sides acrylic coated, polypropylene film with both sides PVDC coated, chemically treated polyester film, corona treated polyester film, PVDC coated polyester film, aluminum foil, and paper products such as coated paper, cardboard, corrugated paper, and the like The substrate may be at room temperature or may be pre-heated before coating, and optionally cooled by chill rollers after coating.

The linear alcohol may be present in the coating composition in an amount of 5-40 wt. %, preferably about 10-30 wt. %. The thermoplastic binder may be present in an amount of 35-65 wt. %, preferably about 45-60 wt. %. The wax may be present in an amount of 5-50 wt. %, preferably about 30-40 wt. %. The solid plasticizer may be present in an amount of 3-15 wt. %, preferably about 5-10 wt. %.

The solvent free coating compositions of this invention will now be illustrated by the following Examples, which are not intended to be in any way limiting.

### EXAMPLE 1

The solvent free coating composition of the present invention was prepared with the following ingredients set forth in Table 1 below:

TABLE 1

| Component | Grams |
|---|---|
| Unilin wax X-1152 (C > 14 alcohol | 10 |
| and homopolymer) | |
| AC 5120 (Allied Signal) (an | 55 |
| ethylene-acrylic acid copolymer) | |
| VBAR 253 polymer (paraffin Wax) | 35 |
| TOTAL | 100 |

All three ingredients were added and maintained at a temperature of 125° C. for a period of 3-4 hours until all materials were melted. The melted materials were mixed at high speed for 5-10 minutes and poured into a container to solidify at room temperature.

The viscosity of the coating composition was measured at 85 cps at 120° C. The viscosity was determined at the designated temperature using a Carri-Med AR1000 Rheometer. A graphical representation of the viscosity of the coating at varying temperatures is set forth in Graph 1 below:

[image]

The hot melt clear coating composition sample was tested by ASTM standard method on “Mocon” instrument model # DL 100 at various temperatures and thickness to measure Moisture-Vapor-Transmission-Rate (MVTR) value as indicated in Table 2 below.

TABLE 2

| | | | Mocon readings* |
|---|---|---|---|
| Temperature | Thickness | | (g/100 sq. in./day) |
| 115° C. | 0.5 | ml | Over Range |
| 115° C. | 1.0 | ml | 0.4050 |
| 115° C. | 1.5 | ml | 0.3361 |
| 130° C. | 0.5 | ml | 1.3355 |
| 130° C. | 0.75 | ml | 0.5749 |
| 130° C. | 1.0 | ml | 0.4050 |
| 130° C. | 1.5 | ml | 0.9046 |

*reading is the average of two measurements.

The above MVTR values (less than 2 grams/100 sq.in./day) achieved with the coating composition meets the ASTM standard.

Those skilled in the art having the benefit of the teachings of the present invention as hereinabove set forth, can effect numerous modifications thereto. These modifications are to be construed as being encompassed within the scope of the present invention as set forth in the appended claims.

What is claimed is:

1. A solvent free coating composition comprising:
(A) a solid linear alcohol at room temperature;
(B) a thermoplastic binder; and
(C) a wax;
wherein, the coating composition is solid at room temperature, has a melting point of at least about 75° C., and when heated to a temperature between about 90° C. and about 135° C., forms a coating composition which has a coating viscosity between about 100 cps and about 1200 cps.

2. The coating composition of claim 1, wherein the viscosity is between about 100 cps and about 700 cps.

3. The coating composition of claim 1, wherein the solid linear alcohol is a fully saturated, long-chain linear alcohol having a melting point of about 75° C. or greater and a number-average molecular weight (Mn) of about 350 or greater.

4. The coating composition of claim 3, wherein the linear alcohol has a Mn between about 350 and about 750 and a melting point between about 75° C. and about 110° C.

5. The coating composition of claim 3, wherein the linear alcohol has a Mn of about 550, a melting point of about 99° C., a hydroxyl number of about 83, and a viscosity at 149° C. of about 5.5 cps.

6. The coating composition of claim 1, wherein the thermoplastic binder is selected from the group consisting of ethylene copolymers, hydrocarbon resins, and a combination thereof.

7. The coating composition of claim 6, wherein the thermoplastic binder is an ethylene copolymer.

8. The coating composition of claim 7, wherein the ethylene copolymer is selected from the group consisting of ethylene-acrylic acid copolymers, ethylene-vinyl acetate copolymers, and combinations thereof.

9. The coating composition of claim 8, wherein the ethylene copolymer is an ethylene-acrylic acid copolymer.

10. The coating composition of claim 9, wherein the ethylene-acrylic acid copolymer has an acid number of about 40 and about 120 and a Brookfield viscosity at 140° C. of about 100 cps to about 1000 cps.

11. The coating composition of claim 9, wherein the ethylene-acrylic acid copolymer has an acid number of about 120 and a Brookfield viscosity at 140° C. of about 650 cps.

12. The coating composition of claim 8, wherein the ethylene copolymer is an ethylene-vinyl acetate copolymer.

13. The coating composition of claim 12, wherein the ethylene-vinyl acetate copolymer contains between about 15 wt. % to about 50 wt. %, based on the weight of the copolymer, of vinyl acetate.

14. The coating composition of claim 12, wherein the ethylene-vinyl acetate copolymer contains about 40 wt. %, based on the weight of the copolymer, of vinyl acetate and has a Melt Index of about 52.

15. The coating composition of claim 1, wherein the thermoplastic binder is present in an amount from about 35 wt. % to about 65 wt. %.

16. The coating composition of claim 1, wherein the thermoplastic binder is present in an amount from about 45 wt. % to about 60 wt. %.

17. The coating composition of claim 1, wherein the wax is selected from the group consisting of highly branched hydrocarbon waxes, polyethylene homopolymer waxes, oxidized polyethylene waxes, animal waxes, vegetable waxes, and combinations thereof.

18. The coating composition of claim 17, wherein the wax is a highly branched hydrocarbon wax.

19. The coating composition of claim 17, wherein the highly branched hydrocarbon wax has a number average molecular weight (Mn) of about 520, a softening point of about 67° C., and a viscosity at 99° C. of about 6 cps.

20. The coating composition of claim 17 wherein the wax is a polyethylene homopolymer wax.

21. The coating composition of claim 20, wherein the polyethylene homopolymer wax is polyethylene having a number average molecular weight (Mn) of about 1000-1200, a molecular weight distribution of about 1 to about 2, and a melting point of about 82° C. to about 104° C.

22. The coating composition of claim 21, wherein the molecular weight distribution is from about 1.2 to about 1.5.

23. The coating composition of claim 17, wherein the wax is an animal wax.

24. The coating composition of claim 23, wherein the animal wax is a spermaceti wax.

25. The coating composition of claim 1, wherein the wax is present in an amount from about 5 wt. % to about 50 wt. %.

26. The coating composition of claim 1, wherein the wax is present from about 30 wt. % to about 40 wt. %.

27. The coating composition of claim 1 further comprising a solid plasticizer.

28. The coating composition of claim 27, wherein the solid plasticizer is dicyclohexylphthalate.

29. The coating composition of claim 27, wherein the solid plasticizer is present in amount from about 3 wt. % to about 15 wt. %.

30. The coating composition of claim 27, wherein the solid plasticizer is from about 5 wt. % to about 10 wt. %.

31. A hot melt coating composition comprising the coating composition of claim 1.

32. A flexographic printing coating composition comprising the coating composition of claim 1 and a pigment.

33. A method of preparing a hot melt coating composition comprising: providing a coating composition having:
(A) a linear alcohol which is a solid at room temperature;
(B) a thermoplastic binder;
(C) a wax; and
heating the coating composition to a temperature between about 90° C. and about 135° C. to form a hot melt coating composition which has a coating viscosity between about 100 cps and about 1200 cps.

34. The method of claim 33, wherein the coating composition has a coating viscosity between about 100 cps and about 700 cps.

35. A method for preparing a flexographic printing coating composition for hot melt flexographic printing comprising:
(A) preparing a pigment dispersion by mixing a pigment with a solid linear alcohol and heating to a temperature above the melting point of the alcohol;
(B) preparing a varnish by mixing (i) a thermoplastic binder and (ii) a wax and heating to a temperature above the melting point of the varnish mixture; and
(C) adding the pigment dispersion to the varnish and mixing to form a homogenous coating composition with a coating viscosity between about 100 cps and about 1200 cps at a temperature between about 90° C. and about 135° C.

36. The method of claim 35, wherein the viscosity is between about 100 cps and about 700 cps.

37. The method of claim 35, wherein the homogenous coating composition is cooled to room temperature to form a solid flexographic printing coating composition.

38. The method of claim 35, wherein the pigment dispersion is cooled to room temperature to form a solid prior to step (C).
